(19) United States
(12) Patent Application Publication
(10) Pub. No.: US 2003/0151660 A1
(43) Pub. Date: Aug. 14, 2003

(54) Binocular telescope with photographing function

(75) Inventors: Ken Hirunuma, Tokyo (JP); Gouji Funatsu, Saitama (JP); Masami Shirai, Saitama (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/360,717

(22) Filed: Feb. 10, 2003

(30) Foreign Application Priority Data
Feb. 14, 2002 (JP) P2002-036343

(51) Int. Cl. H04N 15/00

(52) U.S. Cl. 348/42; 348/79

(57) ABSTRACT

A binocular telescope with a photographing function, comprises a casing, a camera provided with an imaging device, and a connecting terminal. The connecting terminal outputs image data obtained by the imaging device of the camera to a device outside of the binocular telescope. The connecting terminal is provided on a front wall of the casing.

### BACKGROUND OF THE INVENTION

1. Field of the Invention

The present invention relates to a binocular telescope with a photographing function.

2. Description of the Related Art

As is well known, a binocular telescope is used for watching sports, wild birds, and so on. When using such a binocular telescope, it is often the case that the user sees something that he or she would like to photograph. Typically, he or she will fail to photograph the desired scene because he or she must change a camera for the binocular telescope and during this time the chance is lost. For this reason, a binocular telescope containing a digital camera is proposed, whereby a photograph can be taken immediately by using the digital camera contained in the binocular telescope while continuing the observation through the binocular telescope.

The binocular telescope can be provided with an output terminal such as a video terminal and a USB terminal in a similar way as a usual digital camera, so that a subject image captured by the binocular telescope can be indicated on a TV monitor, for example, as a moving image, or transmitted to a personal computer, in real time.

On the other hand, to ensure uninterrupted operation of the binocular telescope for a long time, it is necessary to provide the binocular telescope with an AC power source or a large-capacity power pack. In this case, the binocular telescope has to be provided with an external power source input terminal.

The main function of the binocular telescope is that of a pair of binoculars. Namely, the time for which the binocular telescope is held by hand is much longer than the time a camera is held. Therefore, both side surfaces of the casing of the binocular telescope should be shaped so that the user can hold the binocular telescope stably for a long time. However, if the binocular telescope is small sized as disclosed in Japanese Unexamined Patent Publication No. 10-115764, i.e., a flat type binocular telescope, in which the casings can be slidably moved rightward and leftward to adjust the distance between the optical axes of the right and left telescopic optical systems, the degree of freedom is not high enough to arrange the output terminal or the external power source input terminal on any surface of the binocular telescope.

### SUMMARY OF THE INVENTION

Therefore, an object of the present invention is to provide a binocular telescope with a photographing function, in which an output or input terminal is provided so as not to disturb the handling of the binocular telescope.

According to the present invention, there is provided a binocular telescope with a photographing function, the binocular telescope comprising a casing having a front wall, a camera that is provided with an imaging device, and a connecting terminal that outputs image data obtained by the camera to a device outside the binocular telescope. The connecting terminal is provided on the front wall.

The binocular telescope may further comprise a lid that opens and closes to cover the connecting terminal. In this case, the lid is provided on the front wall.

When the casing comprises first and second casing sections in which right and left telescopic optical systems are housed, and the first and second casing sections are movable relative to each other in such a manner that the distance between the optical axes of the first and second telescopic optical systems is adjusted, the connecting terminal is provided on an end portion of one of the first and second casing sections.

The connecting terminal may comprise a video terminal or a USB terminal.

Further, according to the present invention, there is provided a binocular telescope with a photographing function, the binocular telescope may comprise a casing having a front wall and a battery chamber, in which a battery is housed, and which has an opening provided on the front wall to change the battery, and a lid that opens and closes the opening.

In the binocular telescope, a dummy battery may be housed in the battery chamber when electric power is supplied to the binocular telescope from an external power source. The dummy battery and the power source are connected through a power supply cord. In this case, the lid has a notch, through which the power supply cord passes.

The battery chamber may be provided with an external power source input terminal, to which a connector, provided on an external power source input terminal connected to an external power source, is connected. In this case, the lid has an access hole, through which the power supply cord passes.

The casing may comprise first and second casing sections in which right and left telescopic optical systems are housed. The first and second casing sections are movable relative to each other in such a manner that the distance between the optical axes of the first and second telescopic optical systems is adjusted. The battery chamber is disposed in an end portion of one of the first and second casing sections.

Furthermore, according to the present invention, there is provided a binocular telescope with a photographing function, comprising a casing, a camera, and a connecting terminal. The casing has first and second casing sections in which right and left telescopic optical systems are housed. The first and second casing sections are movable relative to each other in such a manner that the distance between the optical axes of the first and second telescopic optical systems is adjusted. The first casing section is provided with a battery chamber at an outer end portion thereof, in which a battery is housed. The camera is provided with an imaging device. The connecting terminal outputs image data obtained by the camera to a device outside of the binocular telescope. The connecting terminal is provided at an outer end portion of the front wall of the second casing section.

### BRIEF DESCRIPTION OF THE DRAWINGS

The objects and advantages of the present invention will be better understood from the following description, with reference to the accompanying drawings in which:

FIG. 1 is a plan view of a flat type binocular telescope with a photographing function, to which a first embodiment of according to the present invention is applied;

FIG. 2 is a front view of the flat type binocular telescope, in which a movable casing section is push into a main casing section;

FIG. 3 is a front view of the flat type binocular telescope, in which the movable casing section is pulled out of the main casing section;

FIG. 4 is a side view of the flat type binocular telescope;

FIG. 5 is a front view of the flat type binocular telescope, in which a terminal lid and a battery lid are open;

FIG. 6 is a plan view of the flat type binocular telescope, in which a video connector is connected to a video terminal, and a dummy battery is mounted in a battery chamber; and

FIG. 7 is a front view of the flat type binocular telescope of a second embodiment.

### DESCRIPTION OF THE PREFERRED EMBODIMENTS

The present invention will be described below with reference to the embodiments shown in the drawings.

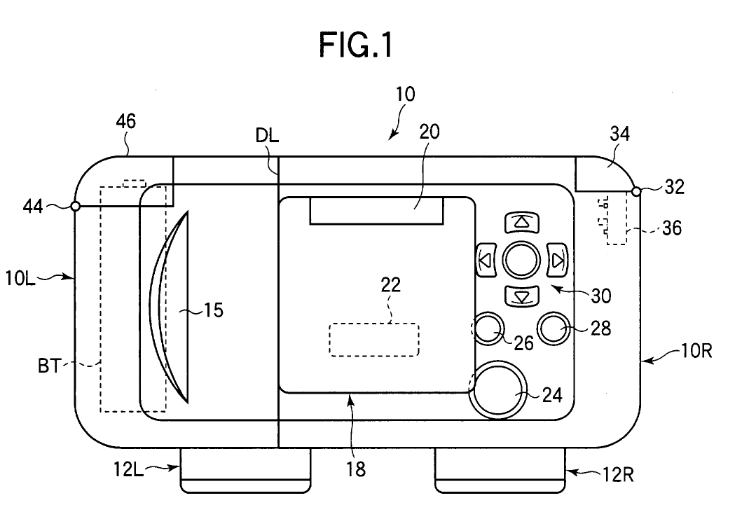

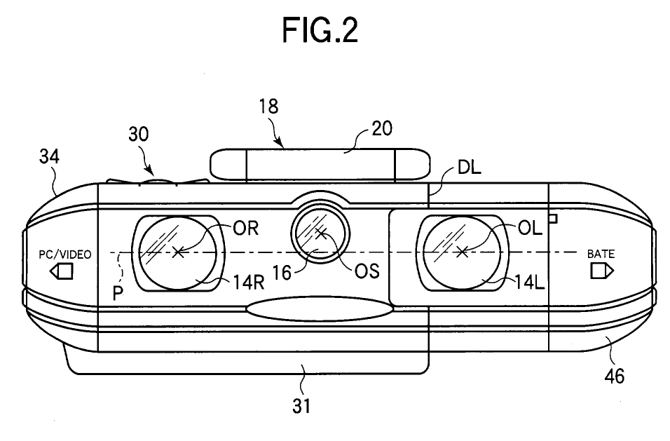

FIG. 1 shows a plan view of a first embodiment of a flat type binocular telescope with a photographing function, and FIG. 2 shows a front view of the binocular telescope. The binocular telescope has a box-like casing 10, which is composed of a main casing section or right casing section 10R and a movable casing section or left casing section 10L. A pair of telescopic optical systems, i.e., a right telescopic optical system and a left telescopic optical system are housed in the right and left casing sections 10R and 10L. Each of the telescopic optical systems is composed of an objective lens system, an erecting prism system, and an ocular lens system.

The ocular lens systems of the right and left telescopic optical systems are housed in lens barrels 12R and 12L. The objective lens systems 14R and 14L of the right and left telescopic optical systems are fixed to the right and left casing sections 10R and 10L, and the erecting prism systems and the ocular lens systems are movable relative to the objective lens systems, so that a focusing operation of the pair of telescopic optical systems is performed. Thus, in the focusing operation of the telescopic optical systems, the lens barrels 12R and 12L are moved backward and forward relative to the casing sections 10R and 10L.

Note that for simplicity of explanation, in the following description, the right side and left side are defined as right side and left side when the user faces the objective lens systems of the telescopic optical systems, and the front and back are respectively defined as the side of the objective lens and the side of the ocular lens systems.

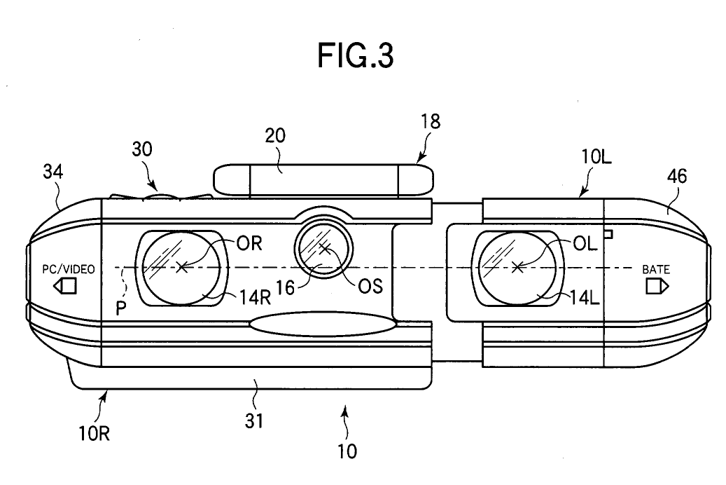

In FIGS. 1 and 2, the right and left casing sections 10R and 10L are divided at a dividing line DL. The right and left casing sections 10R and 10L are movable relative to each other in the right and left directions about the dividing line DL, as shown in FIG. 3. Since the right and left telescopic optical systems are mounted in the right and left casing sections 10R and 10L, when the right and left casing sections 10R and 10L are relatively moved in the right and left directions, the distance between the optical axes of the right and left telescopic optical systems, i.e., the interpupillary distance, is adjusted.

A crescent-like recess 15 is formed on an upper surface of the movable casing section or left casing section 10L. The user can make his or her finger engage with the crescent-like recess 15, so that the left casing section 10L can easily be pulled out of the right casing section 10R.

A photographing optical system 16 is assembled in the main casing section or right casing section 10R. The photographing optical system 16 is housed in a lens barrel (not shown), which is mounted in the right casing section 10R such that the lens barrel is positioned between the right and left telescopic optical systems. Further, a solid state imaging device such as a CCD imaging device is assembled in the right casing section 10R, and arranged at a predetermined position behind the photographing optical system 16. Thus, a digital camera provided with the CCD imaging device and the photographing optical system 16 is housed in the right casing section 10R.

The optical axis OS of the photographing optical system 16 is located between the optical axes OR and OL of the right and left telescopic optical systems which are parallel to each other and parallel to the optical axis OS. As shown in FIGS. 2 and 3, the optical axes OR and OL of the right and left telescopic optical systems define a plane P, which is parallel to the optical axis OS of the photographing optical system 16. The right and left telescopic optical systems are moved in parallel to the plane P, so that the distance between the optical axes thereof, i.e., interpupillary distance is adjusted.

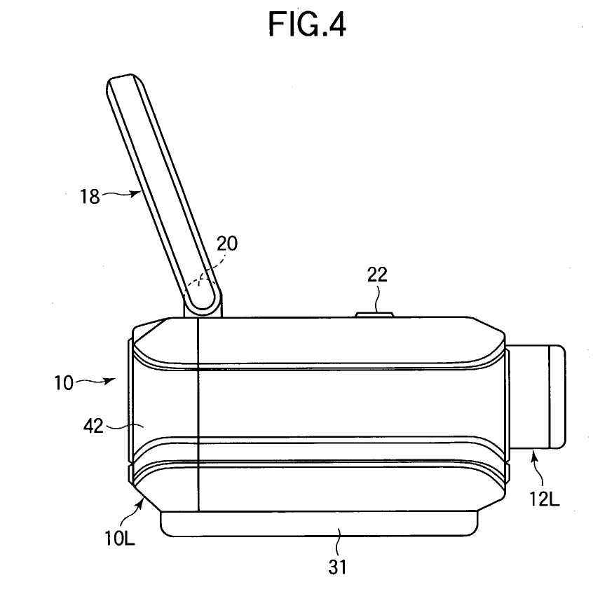

An LCD (liquid crystal display) monitor 18 is provided on an upper surface of the right casing section or main casing section 10R. The LCD monitor 18 has a flat rectangular plate shape. The LCD monitor 18 is arranged in such a manner that its front and rear sides, positioned at opposite sides, are perpendicular to the optical axis of the photographing optical system 16, and the LCD monitor 18 is rotatable about a rotational shaft 20 provided along the front side. The LCD monitor 18 is usually folded or closed as shown in FIGS. 1-3. In this condition, since the display surface of the LCD monitor 18 faces an upper surface of the right casing section 10R, the display surface cannot be seen. Conversely, when the LCD monitor 18 is rotated about the rotational shaft 20 and raised as shown in FIG. 4, the display surface can be seen from the side of the ocular lens systems of the telescopic optical systems.

A rotary wheel 22 is provided in the right casing section 10R. A part of the rotary wheel 60 is exposed from an upper surface of the right casing section 10R as shown in FIG. 4. The rotary wheel 22 is formed on an outer surface of a rotary wheel cylinder (not shown) rotatably supported in the right casing section 10R. When the rotary wheel cylinder is rotated through the rotary wheel 22, the lens barrel 12R and 12L are moved forward and rearward, so that a focusing operation of the telescopic optical systems is performed. Namely, for the focusing of the telescopic optical systems, a movement-conversion mechanism for converting a rotational movement of the rotary wheel cylinder into a focusing movement of the pair of lens barrels 12R and 12L is provided in the rotary wheel cylinder.

In the embodiment, the lens barrel of the photographing optical system 16 is housed in the rotary wheel cylinder of the rotary wheel 22, and is moved along the optical axis of the photographing optical system 16 when the rotary wheel cylinder is rotated. Namely, for the focusing of the photographing optical system for the CCD imaging device, a movement-conversion mechanism for converting a rotational movement of the rotary wheel cylinder into a focusing movement of the lens barrel is provided between the rotary wheel cylinder and the lens barrel.

Thus, when a focusing condition of the right and left telescopic optical systems is obtained by rotating the rotary wheel 22, a focusing condition of the photographing optical system for the CCD imaging device is also obtained. Note that, when the LCD monitor 18 is folded as shown in FIGS. 1-3, the rotary wheel 22 is covered with the LCD monitor 18.

As shown in FIG. 1, various kinds of switch buttons including a release switch button 24, an object indicating switch button 26, a menu indicating switch button 28, and a cross switch button 30 are provided on an upper surface of the right casing section 10R. These switch buttons are arranged in such a manner that, when the LCD monitor 18 is folded, the switch buttons are exposed on the upper surface of the right casing section 10R near the right side of the LCD monitor 18. A power source switch button is provided on a proper portion of the casing 10, that is, a bottom surface of the right casing section 10R, for example. The power source switch button is connected to a power switch of an electric circuit, and when the power switch is turned OFF, the operation of the release switch button 24 is made invalid. The operation of the release switch is made valid when the power switch is turned ON.

The switch buttons 24, 26, 28, and 30 are connected to switches provided in a control circuit board mounted in the right casing section 10R. The control circuit board is provided with a microcomputer, which monitors whether or not the switches connected to the switch buttons 24, 26, 28, and 30 are turned ON. When any switch is turned ON, the microcomputer carries out the corresponding operation.

The release switch button 24 is connected to the release switch, and when the release switch is turned ON, a photographing operation is performed in a way described later.

The object indicating switch button 26 is connected to a select switch for determining whether or not an object image is to be indicated as a moving image, on the display surface of the LCD monitor 18. Right after the power switch is turned ON, a non-indication state is set, in which nothing is indicated on the display surface of the LCD monitor 18. When the object indicating switch button 26 is depressed to turn ON the select switch, an object image, obtained by the CCD imaging device through the photographing optical system 16, is indicated as a moving image on the display surface of the LCD monitor 18. When the object indicating switch button 26 is again depressed to turn ON the select switch, the display surface of the LCD monitor 18 is returned to the non-indication state.

The menu indicating switch button 28 is connected to a select switch for determining whether or not a menu selecting frame is to be indicated on the display surface of the LCD monitor 18. Right after the power switch is turned ON, the non-indication state is set. When the menu indicating switch button 28 is depressed to turn ON the select switch, a menu selecting frame indicating various kinds of set items is indicated on the display surface of the LCD monitor 18. Under this condition, one of the set items is selected and set by operating the cross switch 30. When the menu indicating switch button 28 is again depressed, the display surface of the LCD monitor 18 is returned to the non-indication state.

When the object indicating switch button 26 is depressed after the power switch is turned ON, an object image formed on a light-receiving surface of the CCD imaging device is photoelectrically converted into one frame's worth of image signal. The image signal is read out from the CCD imaging device at predetermined time intervals, subjected to an imaging process, and converted into one frame's worth of digital image data. Then, the one frame's worth of image data is temporarily stored in a frame memory provided on the control circuit board, and read out from the frame memory as a digital video signal. The digital video signal is then converted into an analog video signal, subjected to an imaging process, and transmitted to the LCD monitor 18, so that the object image is indicated as a moving image on the display surface of the LCD monitor 18. If the object indicating switch button 26 is again depressed, the display surface of the LCD monitor 18 is returned to the non-indication state.

When the release switch button 24 is depressed to turn ON the release switch, the one frame's worth of image data stored in the frame memory is read out as still image data, and temporarily stored in a memory provided in the microcomputer on the control circuit. The image data is subjected to a predetermined imaging process by the microcomputer, and written in a memory card, for example, in a predetermined format.

As shown in FIG. 2, a bulge portion 31 is provided on a bottom of the right casing section 10R, and a card holder for the memory card, the control circuit board, and so on are housed in the bulge portion. The memory card is detachably attached to the card holder. After the still image data is recorded in the memory card, the memory card is detached from the card holder in accordance with necessity, and mounted in a memory card driver of an image processing computer, for example, so that the still image data is subjected to an imaging process, and output by a printer as a photographed image.

In the embodiment, a video signal for indicating the object image on the LCD monitor 18 is transmitted to a device outside of the binocular telescope, so that the object image is indicated by an external TV monitor device. Thus, the object image obtained by the photographing optical system 16 is indicated on the external TV monitor, as an observed object image observed by the pair of telescopic optical systems, so that the observed object image can be seen by a lot of observers through the external TV monitor device.

Further, in the embodiment, the binocular telescope with a photographing function is connected to a portable personal computer, so that still image data recorded in the memory card is transmitted to the portable personal computer as needed. Due to this function and by using a cellular telephone, a still image obtained by the binocular telescope can be transmitted to anywhere in the world in real time.

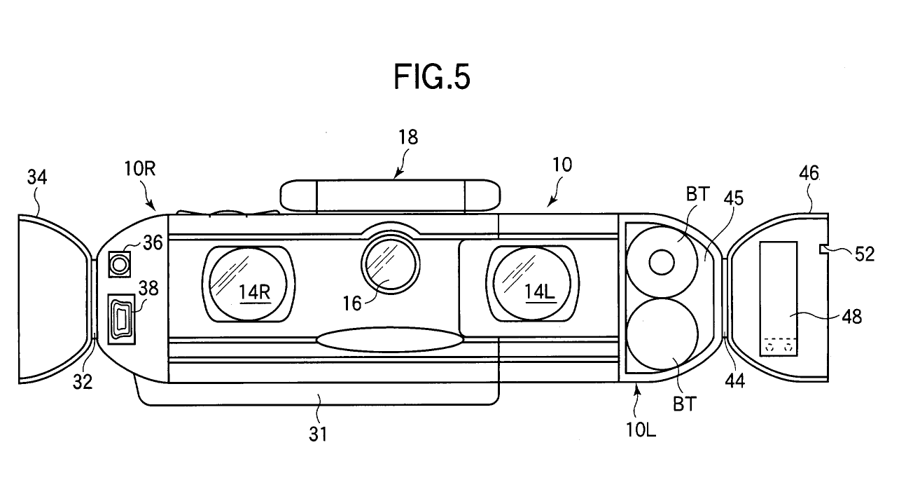

Thus, in the embodiment, as shown in FIG. 5, a video terminal 36 for video signal transmission and a USB terminal 38 for still image data transmission are provided in the binocular telescope, and are disposed in a right end portion of a front wall of the main casing section or right casing section 10R. Namely, a rotational shaft 32 is fixed to the right end portion of the front wall of the right casing section 10R, and a terminal lid 34 is rotatably supported by the rotational shaft 32 to open and close to cover the connecting terminal including the video terminal 36 and the USB terminal 38.

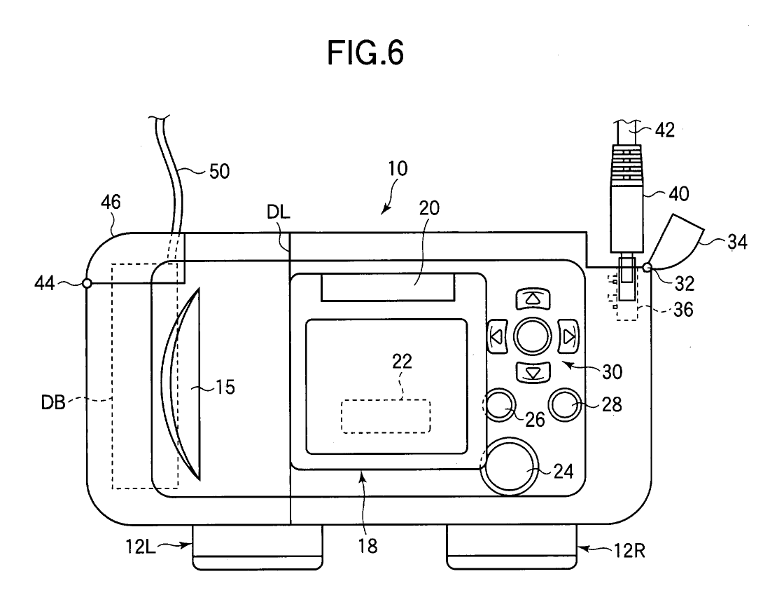

As shown in FIG. 6, when a video connector 40 is connected to the video terminal 36, a connecting cord 42 connected to the video connector 40 extends from the front wall of the right casing section 10R. Therefore, when the right side portion of the right casing section 10R is held by the right hand of the user to observe an object with the binocular telescope, the connecting cord does not interfere with the handling-of the binocular telescope.

On the other hand, as shown in FIG. 1, a battery chamber is formed in a left end portion of the movable casing section or left casing section 10L. The battery chamber is open at the front wall of the left casing section 10L, and the opening is open and closed by a battery lid 46 rotatably supported by a rotational shaft 44. As shown in FIG. 5, in which the battery lid 46 is open, two batteries BT are housed in the battery chamber 45, and the different electrodes of the batteries BT are exposed.

As shown in FIG. 5, a conductor flat spring 48, made of appropriate metal, is attached to a rear surface of the battery lid 46. When the battery lid 46 is closed as shown in FIG. 1, the conductor flat spring 48 comes into contact with the electrodes of the two batteries BT, so that the batteries are electrically connected to each other. Further, when the battery lid 46 is closed, the two batteries BT are elastically urged by the conductor flat spring 48 into the battery chamber 45, so that electrode provided on the opposite sides of the batteries firmly come into electrical contact with the electric terminal not shown.

In the embodiment, instead of the batteries BT, an external power source such as an AC power source adaptor or a large-capacity power pack can be utilized. When the AC power source adaptor or the large-capacity power pack is used, the batteries BT are removed from the battery chamber 45, and a dummy battery DB is mounted, as a power supply connector, in the battery chamber 45 as shown in FIG. 6. The dummy battery DB is in the form of the two batteries BT, so that the dummy battery DB is tightly fit in the battery chamber 45. A tip portion of the dummy battery DB is provided with power supply terminals which are in contact with power supply terminals provided in the battery chamber 45. Namely, when the dummy battery DB is housed in the battery chamber 45, the power supply terminals of the battery chamber 45 and the power supply terminals of the dummy battery DB come into contact with each other, so that electric power can be supplied from the AC power source adaptor or the large-capacity power pack to the binocular telescope.

A power supply cord 50 is extended from the dummy battery DB, and reaches the AC power source adaptor or the large-capacity power pack. As shown in FIG. 5, a notch 52 is formed in a side periphery of the battery lid 46, and thus, when the battery lid 46 is closed as shown in FIG. 6, the power supply cord 50 passes through the notch 52, and extends to outside of the binocular telescope. Thus, since the power supply cord 50 is extended from the front wall of the left casing section 10L, when the left side portion of the left casing section 10L is held by the left hand of the user to observe an object with the binocular telescope, the power supply cord does not interfere with the handling of the binocular telescope.

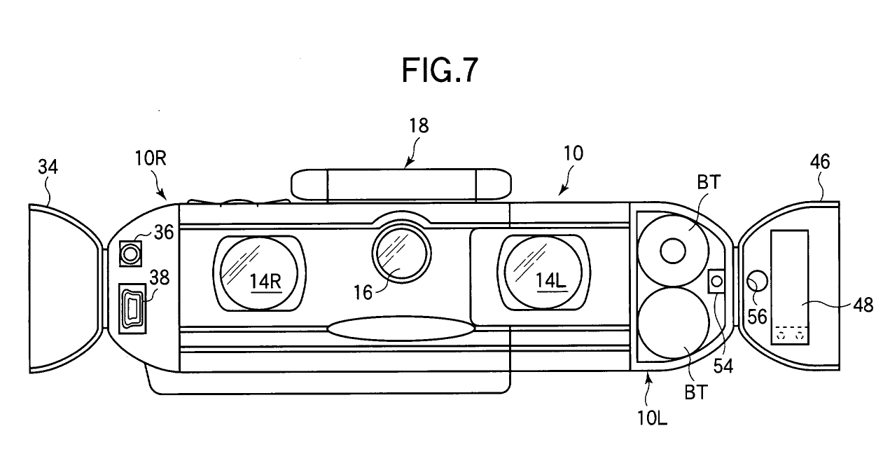

With reference to FIG. 7, a second embodiment of the present invention is described. FIG. 7 corresponds to FIG. 5 of the first embodiment, and in FIG. 7, the corresponding parts to those of FIG. 5 are indicated by the same references.

In the first embodiment shown in FIGS. 1-6, when electric power is supplied from the AC power source adaptor or the large-capacity power pack to the binocular telescope, the dummy battery is used as a power supply connector. Conversely, in the second embodiment shown in FIG. 7, a normal type power supply connector is used. Namely, as shown in FIG. 7, the battery chamber 45 is provided with a socket 54 as an external power source input terminal, to which a connector, provided on an external power source input terminal connected to an external power source, is connected, and an access hole 56 is formed in the battery lid 46. When the battery lid 46 is closed, the socket 54 and the access hole 56 are aligned with each other. Namely, the normal type power supply connector is connected to the socket 54 through the access hole 56, so that electric power is supplied from the AC power source adaptor or the large-capacity power pack to the binocular telescope.

In the first and second embodiments, the video terminal and the USB terminal are provided in the main or right casing section, while the battery chamber is formed in the movable or left casing section. However, the battery chamber may be formed in the right casing section, while the video terminal and the USB terminal are provided in the left casing section.

Further, the first and second embodiments are applied to a flat type binocular telescope, which is the optimum type of binoculars having a photographing function, in which the parallax between the photographed area and the observed area is minimum and the portability is good. However, the present invention can be applied to other binoculars in which interpupillary distance is adjusted by rotating the telescopic optical systems about the photographing optical system.

As described above, in the binocular telescope of the embodiments, since output terminals such as the video terminal and the USB terminal are arranged on the front wall of the casing, when a connecting cord is connected to the output terminal, the connecting cord extends from the front wall. Therefore, when a user holds the casing, the users grip is not interfered with by the connecting cord. Further, if an external power source such as the AC power source adaptor or a large-capacity power pack is used for the binocular telescope, the power supply cord extends from the front wall of the casing, when a user holds the casing, the users grip is not interfered with by the connecting cord. Thus, an observation and a photography can be performed stably, even when the power supply cord of the connecting cord extends from the binocular telescope.

Although the embodiments of the present invention have been described herein with reference to the accompanying drawings, obviously many modifications and changes may be made by those skilled in this art without departing from the scope of the invention.

The present disclosure relates to subject matter contained in Japanese Patent Application No. 2002-036343 (filed on Feb. 14, 2002) which is expressly incorporated herein, by reference, in its entirety.

1. A binocular telescope with a photographing function, comprising:
a casing having a front wall;
a camera that is provided with an imaging device; and
a connecting terminal that outputs image data obtained by said camera to a device outside said binocular telescope, said connecting terminal being provided on said front wall.

2. A binocular telescope according to claim 1, further comprising a lid that opens and closes to cover said connecting terminal, said lid being provided on said front wall.

3. A binocular telescope according to claim 1, wherein said casing comprises first and second casing sections in which right and left telescopic optical systems are housed, said first and second casing sections being movable relative to each other in such a manner that the distance between the optical axes of said first and second telescopic optical systems is adjusted, said connecting terminal being provided on an end portion of one of said first and second casing sections.

4. A binocular telescope according to claim 1, wherein said connecting terminal comprises a video terminal.

5. A binocular telescope according to claim 1, wherein said connecting terminal comprises a USB terminal.

6. A binocular telescope with a photographing function, comprising:
a casing having a front wall and a battery chamber, in which a battery is housed, and which has an opening provided on said front wall to change said battery; and
a lid that opens and closes said opening.

7. A binocular telescope according to claim 6, wherein a dummy battery is housed in said battery chamber when electric power is supplied to said binocular telescope from an external power source, said dummy battery and said power source being connected through a power supply cord, said lid having a notch, through which said power supply cord passes.

8. A binocular telescope according to claim 6, wherein said battery chamber is provided with an external power source input terminal, to which a connector, provided on an external power source input terminal connected to an external power source, is connected, said lid having an access hole through which said power supply cord passes.

9. A binocular telescope according to claim 6, wherein said casing comprises first and second casing sections in which right and left telescopic optical systems are housed, said first and second casing sections being movable relative to each other in such a manner that the distance between the optical axes of said first and second telescopic optical systems is adjusted, said battery chamber being disposed in an end portion of one of said first and second casing sections.

10. A binocular telescope with a photographing function, comprising:
a casing that has first and second casing sections in which right and left telescopic optical systems are housed, said first and second casing sections being movable relative to each other in such a manner that the distance between the optical axes of said first and second telescopic optical systems is adjusted, said first casing section being provided with a battery chamber at an outer end portion thereof, in which a battery is housed;
a camera that is provided with an imaging device; and
a connecting terminal that outputs image data obtained by said camera to a device outside of said binocular telescope, said connecting terminal being provided at an outer end portion of a front wall of said second casing section.
